(19) United States
(12) Patent Application Publication
(10) Pub. No.: US 2006/0039256 A1
(43) Pub. Date: Feb. 23, 2006

(54) Storing apparatus

(76) Inventors: Taku Nakamura, Yokohama (JP); Naozumi Sugimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/136,461

(22) Filed: May 25, 2005

(30) Foreign Application Priority Data
Aug. 23, 2004 (JP) 2004-241792

(51) Int. Cl. G11B 19/02; G11B 5/09

(52) U.S. Cl. 369/47.33; 369/47.1; 369/59.1

(57) ABSTRACT

In a storing apparatus having a built-in recording medium, which stores program files, if there is no method of securing a free capacity of the recording medium, except for deletion of files, a user may have a feeling of resistance against the deletion of stored program files. Further, in securing the free capacity through recompression, there is a limitation to achieving a securable capacity. These problems can be solved by increasing the capacity of the disk to some extent, but this method is insufficient. Thus, a storing apparatus is provided in which, when the capacity of the recording medium is small, selected program stream stored in a hard disk is outputted via a network control unit to an external storage medium, and, after that program stream is outputted, the corresponding program stream is deleted from the hard disk.

### BACKGROUND OF THE INVENTION

The present invention relates to a storing apparatus for storing broadcast programs.

Japanese Patent Laid-Open No. 2003-289490 (hereinafter referred to as Patent Document 1) discloses a storage apparatus which secures a required storage capacity by automatically deleting files, such that a recording medium provided therein can be effectively used and a failure in storing information due to an insufficient capacity can be prevented. In this case, however, since the file deletion is performed by a method uniformly selected and set by a user from many methods, the storage apparatus lacks versatility. In order to solve this problem, in Patent Document 1 discloses a technique in which a broadcast program is stored in a hard disk drive (HDD) 6 or the like, together with data regarding a storage retention condition. Specifically, stored data regarding the storage retention condition is checked by a microprocessor unit (MPU) 7, and selected broadcast programs, based on the storage retention condition, among the broadcast programs stored in the HDD 6 are deleted.

Japanese Patent Laid-Open No. 2002-237141 (hereinafter, referred to as Patent Document 2) discloses an information storage apparatus, such as a digital camera or the like, in which it is possible to increase the number of storage sheets without deleting image data stored in a hard disk, a memory card, or the like. To this end, information to indicate whether or not a recompression is performed, information to indicate a recompression ratio, and information to assign that the recompression has been performed, without changing either the resolution or the image quality, are previously set as additive data in connection with image data. Then, when image data is newly stored, if the free capacity of the storage is small, a desired free capacity to be secured is designated. Accordingly, some of the stored images are recompressed and stored again according to the set information, such that the desired free capacity to be secured can be realized.

Japanese Patent Laid-Open No. 2002-199322 (hereinafter referred to as Patent Document 3) discloses an imaging device in which it is possible to remove the restriction of an imaging time without sacrificing miniaturization, as well as a system using the imaging device. Specifically, the imaging device has a recording medium that stores captured images and a communication unit that communicates with an external image processing device. Here, image data stored in the recording medium is transferred to the external image processing device through the communication unit (see Step S4). Then, when a transmission completion signal is received from the external image processing device (Step S6), a data conversion is performed to reduce the data amount of image data stored in the recording medium (Step S7).

A video storing apparatus which uses a hard disk has experienced widespread use. Further, like digital BS broadcasting, digital terrestrial broadcasting, or the like, broadcasting has been digitized. A digital television (TV) set has been equipped with a recording medium, such as a hard disk, whereby the recording/reproducing of digital broadcasting has become possible. However, it is difficult to replace a hard disk built in the apparatus with another hard disk, for example, a large capacity hard disk. Accordingly, the capacity of the hard disk is restricted to a constant capacity. On the other hand, from the viewpoint of a user, the user may feel that it is inconvenient to delete programs stored in the hard disk, and thus, when the hard disk is full, it is preferable to preferentially secure a free capacity.

Patent Document 1 discloses a technique in which the duration in which to keep programs when storing a program is set by a user, and when the free capacity is deficient, files are deleted. However, in a case in which there is no method of securing the necessary free capacity of the hard disk, except for the deletion of files, it is difficult to secure the free capacity, without causing the user to experience a feeling of resistance against the deletion of the stored programs.

Patent Document 2 discloses a technique in which, in a digital camera, when the free capacity is deficient, a recompression of the stored data is performed to enhance the compression ratio, thereby securing the desired free capacity of the hard disk. However, in securing the free capacity by recompression, the securable free capacity is limited.

Meanwhile, a network technology including the Internet or a LAN (Local Area Network) has become popular and has been introduced into the home. By employing this technology, it becomes possible to transfer image information at a high bit rate. Patent Document 3 discloses a technique in which a communication unit is provided in an imaging device to transfer a captured image to an external image processing device. However, according to Patent Document 3, since it is assumed that the captured image is reproduced in the external image processing device, which serves as a destination in the transfer, the captured image, once it has been transferred, cannot be displayed in the imaging device.

The problems described above can be solved to some extent by increasing the capacity of the hard disk. However, an increase in the capacity of the hard disk is not a basic solution. Further, it is difficult to secure the free capacity, without causing the user to experience a feeling of resistance against the deletion of the stored programs.

Accordingly, when original data is recompressed or is deleted after being transferred to an external apparatus in order to secure the necessary free capacity of the hard disk, the convenience can be enhanced. However, since all of the above-described Patent Documents have given no consideration to how data should be deleted according to any priority, the consideration of priority is problematic.

### SUMMARY OF THE INVENTION

It is an object of the present invention to provide a storing apparatus having enhanced convenience.

According to an aspect of the present invention, a storing apparatus includes a storing/reproducing module which stores and reproduces program streams and program names in a recording medium; a communication module which transfers and receives each program stream stored in the recording medium to and from a server connected to a network; a compression module which compresses each program stream stored in the recording medium to a size smaller than the current size; a priority setting module which automatically sets a priority for deleting each program stream stored in the recording medium according to a predetermined condition; an instruction module which instructs the reproduction of each program stream stored in the recording medium; and a control module which controls the storing/reproducing module, the communication module, and the compression module. When the free capacity of the recording medium is small, the control module controls the compression module to compress each program stream stored in the recording medium to a size smaller than the current size; or, it controls the communication module to transfer the program stream to the server, according to the priority set by the priority setting module, deletes the program stream stored in the recording medium, and retains the program name corresponding to the deleted program stream. When an instruction for reproducing the program stream corresponding to the retained program name is received, the control module controls the storing/reproducing module to reproduce the corresponding compressed program stream, or it controls the communication module to receive the corresponding program stream from the server to reproduce the received program stream.

In accordance with the present invention, it is possible to provide a storing apparatus having enhanced convenience.

### BRIEF DESCRIPTION OF THE DRAWINGS

These and other features, objects and advantages of the present invention will become more apparent from the following description when taken in conjunction with the accompanying drawings, wherein:

FIG. 1 is a block diagram showing a first embodiment of the invention;

FIG. 2 is a flow diagram showing a procedure for moving a program file according to the first embodiment of the invention;

FIG. 3 is a diagram showing a screen for selecting a reproduction of a program file when reproducing the program file;

FIG. 4 is a block diagram showing a second embodiment of the invention;

FIG. 5 is a diagram showing a screen for selecting a folder when storing a program file;

FIG. 6 is a diagram showing a screen for changing a compression ratio according to the number of times of recompression; and

FIG. 7 is a diagram showing a screen for determining a method of moving a file through an interaction with a user.

### DESCRIPTION OF THE PREFERRED EMBODIMENTS

Hereinafter, various embodiments of the present invention will be described with reference to the drawings.

### First Embodiment

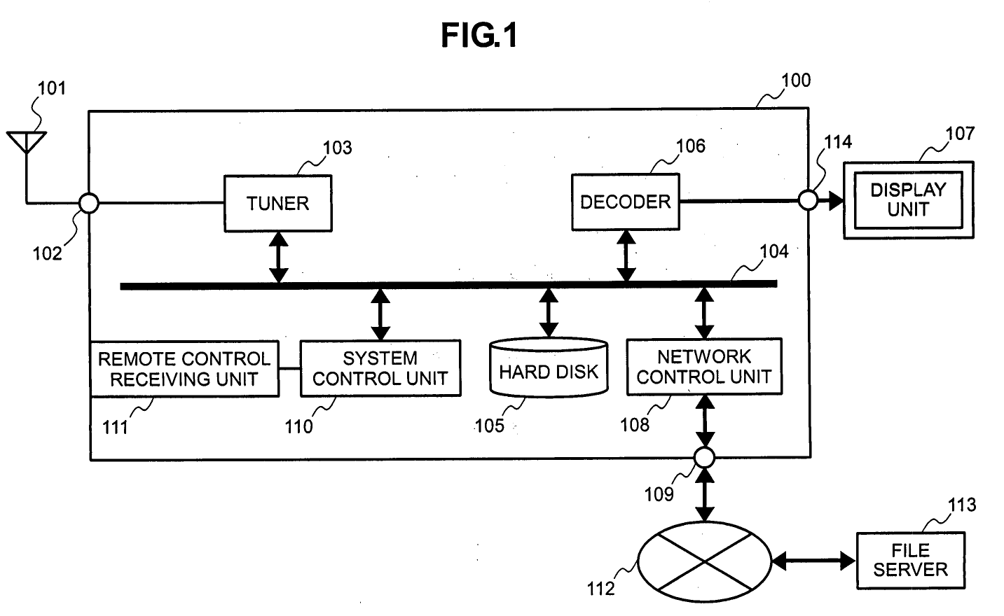

FIG. 1 shows a first embodiment of the present invention.

A storing apparatus 100 includes an antenna input terminal 102, a tuner 103, a data bus 104, a hard disk 105, a decoder 106, a network control unit 108, a network terminal 109, a system control unit 110, a remote control receiving unit 111, and a display unit connection terminal 114. An antenna 101 is connected to the antenna input terminal 102; a display unit 107 is connected to the display unit connection terminal 114; and a network 112 is connected to the network terminal 109.

First, an operation that is performed when recording a program will be described below.

A user sets a timer using a remote control device (not shown) or the like. Timer reservation information from the remote control device is transferred by an infrared ray and is demodulated by the remote control receiving unit 111. Then, the demodulated information is inputted to the system control unit 110. The system control unit 110 performs a reservation operation according to the inputted timer reservation information. In particular, the system control unit 110 stores the timer reservation information in a built-in memory. A timer reservation start time stored in the memory is sequentially compared to the time of a clock in the system control unit 110. When the time of the clock in the system control unit 110 reaches the reservation start time, a timer reservation operation starts.

When the time of the clock in the system control unit 110 reaches a storage start time, first of all, in order to receive a channel to be stored, the system control unit 110 sets the channel of the tuner 103. Here, the tuner 103 is one that is responsive to digital broadcasting. The tuner 103 derives and demodulates the signal to be broadcasted through the specified channel and outputs the demodulated signal in a stream of predetermined digital signals. The stream is outputted, for example, in a 188-byte packet format, which is referred to as MPEG-TS (MPEG Transport Stream).

In order to store the program received by the tuner 103 in the hard disk 105, the system control unit 110 controls and changes the data bus 104, such that the stream outputted from the tuner 103 is inputted to the hard disk 105.

Then, the system control unit 110 sets a storage location, such that the stream is stored in the free capacity in the hard disk 105.

The inputted stream is stored in a designated location of the hard disk 105. At this time, the storage time of each packet in each stream is stored as a time stamp, together with the stream. Accordingly, when reproducing the data, the output interval of the packet can be restored.

When the time of the clock in the system control unit 110 corresponds to a storage completion time, the system control unit 110 instructs storage completion to the hard disk 105. At this time, the system control unit 110 stores information, such as a storage start location and a storage completion location on the hard disk 105, as management information regarding the hard disk 105. In such a manner, the stored stream can be managed as a file. Further, when the storage start time, a storage channel, a program name, and the like are added to the management information, the storage content can be easily discriminated. In such a manner, the timer-reserved program is stored in the hard disk 105.

In the example described above, storage of the program is performed by timer reservation. However, even when a user pushes a record button to store the program during viewing, it is needless to say that the received program can be stored in the hard disk.

Next, an operation that is performed when reproducing a program will be described below.

When the user instructs that a program stored in the hard disk 105 is to be reproduced, the system control unit 110 displays a program list, which includes information, such as the program names and the storage times of the programs stored in the hard disk 105, on the display unit 107, and urges the user to select a program to be reproduced. The user selects a desired program from the displayed program list and instructs that the selected program is to be reproduced.

The system control unit 110 designates the storage location on the hard disk 105 where the selected program is stored and instructs the state of reproduction of data from the hard disk 105.

The hard disk 105 starts the reproduction of data from the predetermined location on the designated disk. In the stored stream, since a time stamp is added to each packet, the output timing of each packet is controlled according to the time stamp. Accordingly, the packets are outputted at the same packet interval as that when the storing occurred.

Next, the system control unit 110 controls the data bus 104 such that the stream reproduced from the hard disk 105 is inputted to the decoder 106. Accordingly, the stream reproduced from the hard disk 105 is inputted to the decoder 106.

The decoder 106 converts the inputted stream into a video signal and a sound signal by decoding the inputted stream. The video signal is inputted to the display unit 107 via the display unit connection terminal 114. The video signal is displayed on the display unit 107 and the sound signal is outputted as a sound from a built-in speaker.

In such a manner, it is possible to reproduce the program stored in the hard disk 105.

In addition, when the stored program has been reproduced, the reproduction date/time or the number of reproduction times is stored in the management information of the program. Accordingly, it is possible to know the final date/time when each program had been reproduced and to discriminate between programs that have not been watched for a long time from programs that have been watched recently.

Sequentially, an operation for moving a program file that is stored in the hard disk 105 will be described.

The user stores various programs in the hard disk 105. However, since the capacity of the hard disk 105 is limited, when the remaining capacity is not sufficient, it is impossible to store programs. Consequently, in the storing apparatus according to the first embodiment of the invention, files of programs having low possibilities to be reproduced hereinafter are automatically moved to a file server 113, which is connected to the network 112.

Here, the programs having low possibilities to be reproduced include, for example, programs that have not been watched for a long time and programs that have an extremely low number of reproduction times. On the contrary, programs that have high possibilities to be reproduced include, for example, programs that have been reproduced repeatedly and programs that have been stored most recently.

According to such information, priorities are given to the programs stored in the hard disk 105. According to the set priorities, the files of the programs that have low possibilities of being reproduced are moved to the file server 113.

The moving of files to the server may be performed, for example, at the time of setting the timer reservation or at the time of the storage completion. Needless to say, the user may consciously instruct movement of a file by using the remote control device or the like.

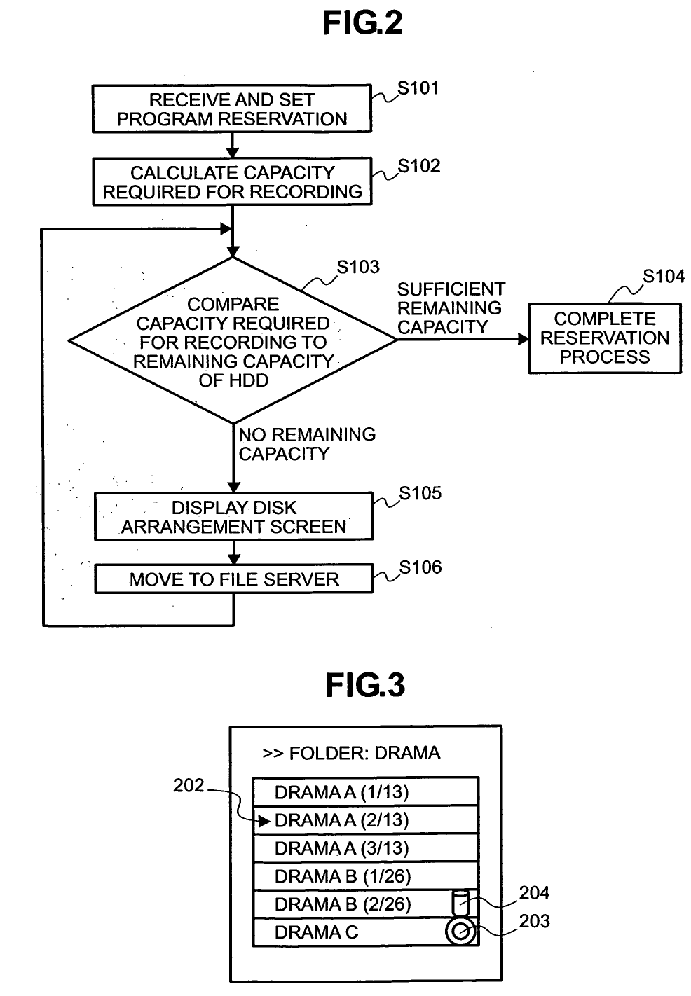

Hereinafter, the movement of a file to the file server 113 will be specifically described with reference to FIG. 2.

First, the user performs a timer reservation using the remote control device. Specifically, in a step S101, the remote control receiving unit 111 receives a signal from the remote control device and outputs the received signal to the system control unit 110. The system control unit 110 performs a timer reservation according to the received timer reservation information and stores the timer reservation information in the built-in memory of the system control unit 110.

Sequentially, in a step S102, the system control unit 110 calculates the storage capacity required for storing from the timer reservation information. Since the timer reservation information includes information such as the storage start time, the storage completion time, the storage channel, and a storage mode, the system control unit 110 calculates a storage time from the storage start time and the storage completion time and multiplies the calculated storage time by the bit rate of storage data obtained from the storage channel or the storage mode. In such a manner, the system control unit 110 calculates the storage capacity required for the timer reservation.

Sequentially, in a step S103, the system control unit 110 calculates the remaining capacity of the hard disk 105. In particular, the system control unit 110 may read the file management information in the hard disk 105 and calculate the size of the unused capacity in the hard disk 105. The system control unit 110 compares the storage capacity required for storing to the remaining capacity of the hard disk and judges whether or not the timer reservation can be performed. At this time, when the remaining capacity is sufficient, the process progresses to a step S104. In the step S104, the system control unit 110 completes the reservation process without moving a file.

If the remaining capacity of the hard disk 105 is smaller than the capacity required for the timer reservation, when the program is stored, since the capacity of the hard disk 105 is deficient, the storing operation is stopped. For this reason, in a step S105, some of the files stored in the hard disk 105 are moved to the file server 113. At this time, as described above, the system control unit 110 estimates whether or not the file of each program stored in the hard disk 105 has a high probability of being reproduced, selects programs having little need to be reserved, and moves the selected program files.

In particular, the system control unit 110 reads the management information of each program stored in the hard disk 105 and gives a necessity ranking to each program, based on the reproduction frequency, the final reproduction date/time, and the file capacity with regard to each program.

Next, the system control unit 110 controls the network control unit 108 to communicate with the file server 113. Sequentially, the system control unit 110 transfers the file of the program stored in the hard disk 105 to the file server 113 via the network control unit 108 and the network 112. Here, in the file transmission, a so-called FTP (File Transfer Protocol) and the like can be used. When the file has been transferred to the file server 113, the system control unit 110 deletes the file that has been transferred from the hard disk 105. Therefore, the remaining capacity of the hard disk 105 is increased. Returning to the step S103, even if one file has been moved, when the remaining capacity of the hard disk 105 is insufficient, it is possible to repeat the file transfer process, and it is possible to perform the control to transfer a plurality of files in advance.

By the above-described process, the capacity of the hard disk is secured. Therefore, it is possible to avoid a situation in which the storage of a program is impossible because the hard disk has insufficient space.

The file transfer can be performed in an asynchronous manner for both the storage and the reproduction. Therefore, even when the file transfer speed is slow or is not constant, there is no possibility of causing a problem in the storage or in the reproduction of data.

In addition, if the program file has been transferred, when information, such as information of the transferred program, the file server name serving as the destination, and the file storage location, is stored in the hard disk 105 that is in the storing apparatus 100, it is easy to acquire the program file again. Specifically, when information, such as the program name, the storage date/time, and a thumbnail image representing the program file, is stored in the hard disk 105, it is possible for the user to acquire the information concerning the program that has been transferred. Further, if necessary, it is easy to select the program from the information, to request the file of the program again, and to reproduce the file.

In the above-described embodiment, when setting the program reservation, or at the time of the storage completion, stream data is automatically transferred. However, as regards the file transfer, various modifications can be achieved. For example, the program stored in the hard disk 105 may be transferred after a predetermined period, for example, a week from the storage date/time. Alternatively, the file may be regularly transferred at a predetermined time, for example, every midnight on Sunday. Further, at the time of the storage start or during storing, the file may be transferred according to the remaining capacity of the disk.

As described above, a program that has been stored by the storing apparatus 100 is transferred to the file server 113 at a predetermined timing. Accordingly, there is no possibility that the hard disk 105 in the storing apparatus will get full, so that a predetermined capacity is always secured. As a result, the user can perform the storage anytime, without being concerned about the remaining capacity of the hard disk 105.

Since the file of the program that has been transferred once from the storing apparatus 100 to the file server 113 can be returned to the storing apparatus 100, the user can still watch the program.

In particular, first, the user instructs the start of reproduction using the remote control device. The signal from the remote control device is inputted to the system control unit 110 via the remote control receiving unit 111. According to the instruction for start of reproduction as received from the remote control device, the system control unit 110 displays a list of the programs that are or have been stored in the hard disk 105, as shown in FIG. 3. At this time, information, such as the program title or a thumbnail of the program that has been transferred to the file server 113 and the storage date/time, is stored in the hard disk 105. Such information can be represented by a server icon 204 displayed with the information stored in the hard disk 105. By recognition of the server icon 204, the programs stored in the hard disk 105 and the programs that have been transferred to the file server 113 can be discriminated, and the user can easily distinguish these programs.

Next, the user selects the desired program using a cursor 202 from the displayed program information and instructs the reproduction of the selected program. When the user selects a program stored in the hard disk 105, the system control unit 110 controls the data bus 104, such that the signal reproduced from the hard disk 105 is inputted to the decoder. When the user selects a program in the file server 113, data from the file server 113 is received in the form of a streaming broadcast and is reproduced. Needless to say, the program file in the file server 113 also may be reproduced after transfer of the program file to the hard disk 105.

When the transfer speed of the network 112 is fast enough, the user can reproduce the program without hardly any concern about whether the program is stored in the hard disk 105 or in the file server 113.

As described above, in the first embodiment of the invention, since the files that have been stored in the hard disk of the storing apparatus are automatically transferred, if necessary, the user does not need to be concerned about the remaining capacity of the hard disk in the storing apparatus. Accordingly, there is no possibility that storage of new files is impossible because the hard disk gets full. Therefore, it is possible to provide a very convenient storing apparatus having an advantage in that the user does not need to consciously delete any files.

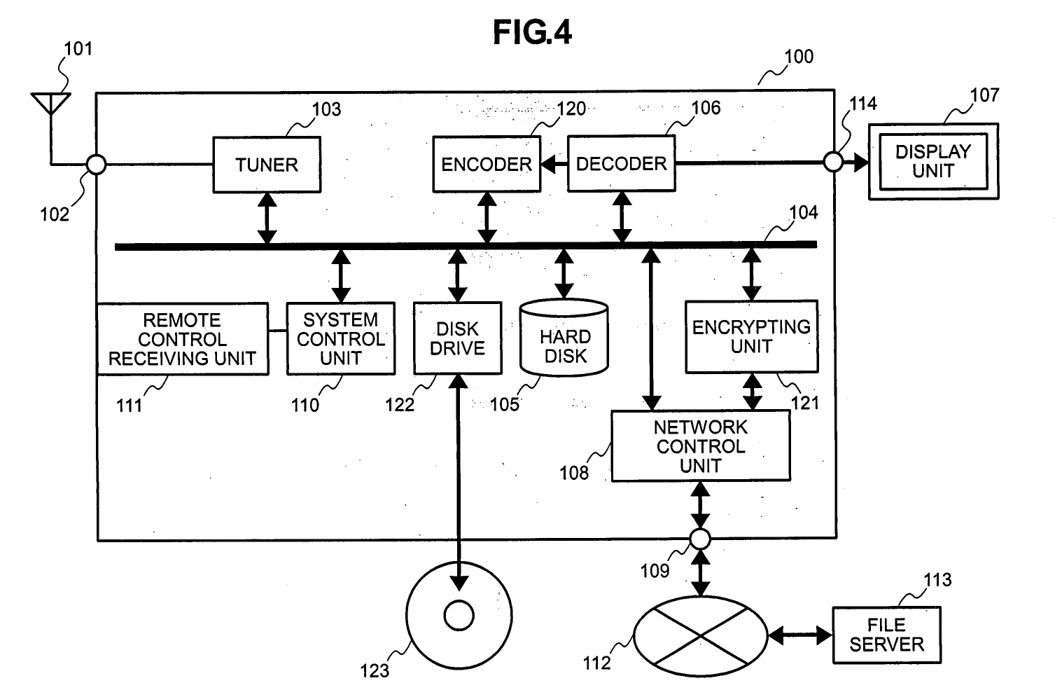

FIG. 4 shows a second embodiment of the invention. In FIG. 4, the same reference numerals are appended to the same elements as those shown in the FIG. 1, and a repeated description thereof will be omitted. In this embodiment, when a program file is transferred from the hard disk 105 to the file server 113, it is possible to lower the bit rate of the program file using an encoder 120. Hereinafter, a method of lowering the bit rate will be described in detail. The system control unit 110 reads the program file from the hard disk 105 and inputs the read program file to the decoder 106 via the data bus 104. The decoder 106 then decodes the stream of the inputted program file and converts the decoded stream into a video signal and a sound signal. The encoder 120 receives and recompresses the video signal and the sound signal so as to generate a recompressed stream of the program file. At this moment, the compression ratio of the video and sound signals is increased and the bit rate is lowered, as compared to the stream of the program file read from the hard disk 105. The system control unit 110 stores the stream of the program file that was outputted from the encoder 120 in the file server 113 via the data bus 104, the network control unit 108, and the network 112. The system control unit 110 confirms that the program file has been transferred to the file server 113 and deletes the program file from the hard disk 105.

In general, when the compression ratio is increased, the image quality deteriorates. However, since the file that is transferred to the file server 113 is a program file having a low probability of being watched, deterioration of the image quality is not a critical matter. When the compression ratio is increased, the size of the file becomes small. Accordingly, it is possible to transfer the file in a short time. Further, since less capacity is required, it is possible to store more files in the file server.

In addition, in this embodiment, when the program file is transferred from the hard disk 105 to the file sever 113, the user can supply a password or a secret code to the program file to be transferred using an encryption unit 121. Hereinafter, a method of supplying a password or a secret code to the program file to be transferred will be described in detail. The system control unit 110 reads the program file from the hard disk 105 and transfers the program file to the network control unit 108. When the program file is transferred, the system control unit 110 controls the data bus 104, such that the program file passes through the encryption unit 122. The encryption unit 122 encrypts the program file by using an encryption method, which is instructed by the system control unit 110, and transfers the encrypted program file to the network control unit 108. When the encrypted program file is reproduced in the storing apparatus 100, the system control unit 110 controls the encryption unit 121, such that the encrypted program file read via the network control unit 108 is decrypted and the decrypted program file is outputted to the data bus 104. Since the program file is stored in the file server 113 after being encrypted, it is possible to prevent other users from reproducing the program file freely. Needless to say, when the program file is stored in the file server, the program file may be stored on a directory, which is different for each user or for each storing apparatus. Thus, a user's access to each directory may be restricted.

In this embodiment, by using the disk drive 122 that is built in the storing apparatus 100, it is possible to transfer the program files that have been stored in the hard disk 105 or the file server 113 to a removable disk 123 in a certain unit. Here, an example of the removable disk includes an optical disk, such as a Blu-ray disk or a DVD.

Hereinafter, a description will be given with reference to FIG. 3. In FIG. 3, the storing apparatus 100 acquires, from information multiplexed to MPEG-TS, information about the total number of installments of the drama A and to which installment of the stored program the information corresponds, and displays the information on the screen. When the thirteenth installment of the drama A is stored, the system control unit 110 reads the program file of the drama A from the hard disk 105 or the file server 113 and stores the read program file in the removable disk 123 via the disk drive 122. Then, the system control unit 110 deletes the program file that has been stored in the hard disk 105 or the file server 113. When the total size of the program file of the drama A exceeds the capacity of the removable disk 123, the system control unit 110 changes the compression ratio of the program file using the decoder 106 and the encoder 120, such that the program file is stored on the removable disk 123. The user can obtain a removable disk related to the drama A after watching the drama A. Therefore, in a case in which miscellaneous files are stored on the file server 113 and, accordingly, the remaining capacity of the file server 113 becomes deficient, the amount of the needed arrangement work can be reduced. In general, since the unit price per bit of an optical disk is less than that of a hard disk, from a cost standpoint, it is advantageous to transfer the program file from the hard disk to the optical disk. When the compression ratio is changed such that the program file of the drama A is stored on the removable disk 123, the image quality can be seriously deteriorated. In this case, the compression ratio can be changed such that the program file of the drama A is stored on two removable disks 123. The transferred program file that is stored on the removable disk can be represented by a disk icon 203 displayed with the program file transferred to the removable disk 123. By recognizing the icon 203, the user can easily understand that the program file is stored in the removable disk.

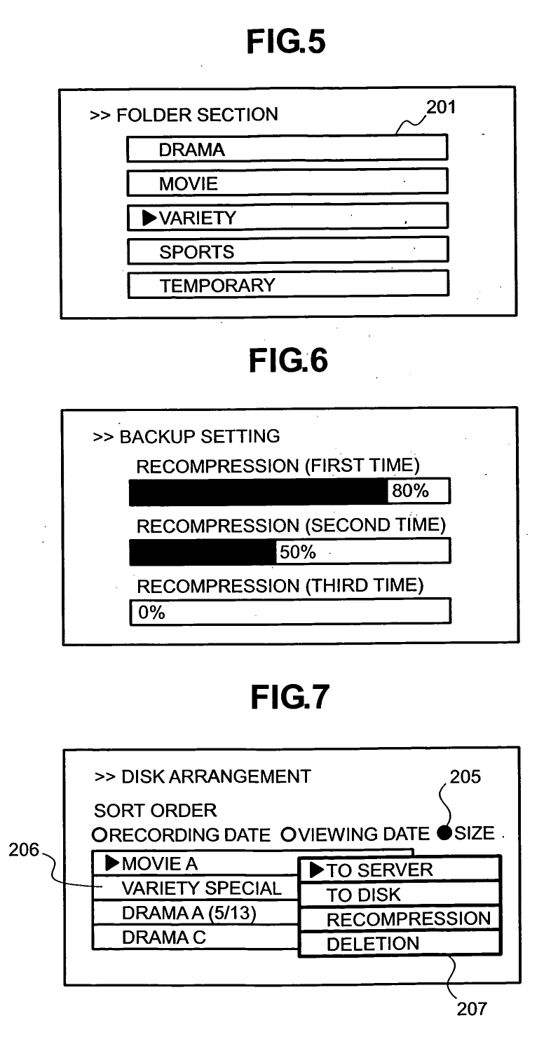

Further, in this embodiment, the programs may be classified into folders for each category, as shown in FIG. 5; and, when the free capacity is deficient, a countermeasure may be determined for each folder. The user selects a folder 201 at the time of the program reservation and a folder to be used for storing. According to the folder, when the free capacity of the hard disk 105 is insufficient, a countermeasure is determined. For example, when the user selects a drama folder, at least one file in the drama folder is recompressed and transferred to the file server 113. When the user selects a movie folder, at least one file in the movie folder is transferred to the file server 113 without being recompressed. When the user selects a temporary folder, at least one file in the temporary folder is recompressed and stored in the hard disk 105. In the case in which at least one file in the temporary folder is recompressed and stored in the hard disk 105, it is possible to change the compression ratio according to the number of times recompression is carried out. For example, as shown in FIG. 6, the first recompression is performed on a predetermined file at the compression ratio of 80%, the second recompression is performed on the predetermined file at the compression ratio of 50%, and the third recompression is performed on the predetermined file at the compression ratio of 0%, that is, the predetermined file is deleted at the time of the third recompression. By performing the file management in steps, it is possible to perform the file management flexibly, as compared to the case in which the file is deleted after expiration of a constant period. Needless to say, as shown in FIG. 7, the storing apparatus may have a function through which the user can control file transfer/recompression/deletion on purpose. FIG. 7 shows a screen to be displayed when the storing apparatus 100 detects that the remaining capacity of the hard disk 105 is insufficient. On the screen, the user selects a sort method of a program menu 206 with a radio button 205 and selects program files to be arranged. Then, a sub menu 207 is opened, allowing the user to select a desired arrangement method from the sub menu 207.

Further, in the above-described embodiments, the network and the file server are not limited to the Internet and a file server provided by a service provider or the like. For example, the network and the file server may be a home network and a home server or a file server connected to the home network.

In the foregoing description of the embodiments, each operation of the storing apparatus has been considered. The operations may be performed by hardware in a storing apparatus or by software. For example, by installing the software later on a storing apparatus, the storing apparatus for implementing the invention can be constructed.

What is claimed is:

1. A storing apparatus comprising:
a storing/reproducing module which stores and reproduces program streams and program names in a recording medium;
a communication module which transmits and receives each program stream stored in the recording medium to and from a server connected to a network;
a compression module which compresses each program stream stored in the recording medium to have a size smaller than a current size;
a priority setting module which automatically sets a priority of deleting each program stream stored in the recording medium according to a predetermined condition;
an instruction module which instructs reproducing each program stream stored in the recording medium; and
a control module which controls the storing/reproducing module, the communication module, and the compression module,
wherein, when a free capacity of the recording medium is small, the control module controls the compression module to compress each program stream stored in the recording medium to have the size smaller than the current size or controls the communication module to transmit the program stream to the server, according to the priority set by the priority setting module, deletes the program stream stored in the recording medium, and leaves the program name corresponding to the deleted program stream, and
when an instruction reproducing the program stream corresponding to the left program name is received, the control module controls the storing/reproducing module to reproduce the corresponding compressed program stream or controls the communication module to receive the corresponding program stream from the server to reproduce the received program stream.

2. A storing apparatus comprising:
a tuner that receives broadcast waves and derives program streams of channels included in the broadcast waves;
a recording medium that stores each program stream;
a decoder that decodes each program stream to a video signal and a sound signal;
a network control unit which outputs each program stream stored in the recording medium to a network via a network connection terminal;
a system control unit which controls the tuner, the recording medium, the decoder, and the network control unit; and
a priority setting module which automatically set a priority of deleting each program stream according to a predetermined condition,
wherein, when the free capacity of the recording medium is small, each program stream stored in the recording medium is outputted to a file server, which is connected to the network, via the network control unit according to the priority set by the priority setting module, and, after each program, stream is outputted, the corresponding program stream-is deleted from the recording medium, and
when reproducing, the corresponding program stream is received from the file server via the network control unit.

3. The storing apparatus according to claim 1,
wherein the predetermined condition includes at least one of date on which each program stream is stored in the recording medium, reproduction times, and a genre.

4. The storing apparatus according to claim 1, further comprising:
an input device which instruct a time at which the storing of each program stream begins,
wherein the free capacity of the recording medium is confirmed when the time at which the storing of each program stream begins is inputted from the input device.

5. The storing apparatus according to claim 4,
wherein the free capacity of the recording medium is confirmed when the storing of each program stream ends according to the time inputted from the input device.

6. The storing apparatus according to claim 4,
wherein the free capacity of the recording medium is confirmed when the storing of each program stream begins according to the time inputted from the input device.

7. The storing apparatus according to claim 4,
wherein the free capacity of the recording medium is confirmed at predetermined intervals during the storing of each program stream according to the time inputted from the input device.

8. The storing apparatus according to claim 2,
wherein, when each program stream stored in the file server is reproduced, the decoder receives the corresponding program stream from the network control unit.

9. The storing apparatus according to claim 2,
wherein, when each program stream stored in the file server is reproduced, the corresponding program stream is outputted from the recording medium to the decoder, after being transferred from the network control unit to the recording medium.

10. The storing apparatus according to claim 4, further comprising:
an encoder which encodes the video signal and the sound signal outputted from the decoder and creates each program stream,
wherein, when each program stream is outputted from the network control unit to the file server, the encoder outputs a program stream having a size smaller than that of each program stream in the recording medium to the network control unit.

11. The storing apparatus according to claim 10,
wherein, when the free capacity of the recording medium is small, each program file in the recording medium is outputted to the decoder, and the encoder stores, in the recording medium, the program stream having the size smaller than that of each program stream in the recording medium and deletes each program stream outputted to the decoder.

12. The storing apparatus according to claim 8, further comprising:
an encryption unit which encrypts each program stream in a predetermined method,
wherein, when each program file in the recording medium is transferred to the file, server, the encryption unit encrypts the program file and outputs the encrypted program file to the network control unit.

13. The storing apparatus according to claim 12,
wherein, when each encrypted program file is read from the file server, the encryption unit decrypts the encrypted program file.

14. The storing apparatus according to claim 1, further comprising:
a drive unit which stores each program file in a removable recording medium,
wherein, after each program file read from the recording medium or the file server is written into the removable recording medium, the program file stored in the recording medium or the file server is deleted.

15. The storing apparatus according to claim 14,
wherein, a plurality of program file from the recording medium or the file server is written into the removable recording medium based on information accompanied to the program files.

16. The storing apparatus according to claim 15,
wherein, when the plurality of program files are written based on the information accompanied to each program file, if the plurality of program files exceed the capacity of the removable recording medium, the size of each program file is reduced by the encoder.

17. The storing apparatus according to claim 2,
wherein a list of the stored program stream is outputted from the decoder as a video signal and a mark is put on each program file transferred to the file server.

18. The storing apparatus according to claim 14,
wherein a list of the stored program stream is outputted from the decoder as a video signal and a mark is put on each program film transferred to the removable recording medium.

19. The storing apparatus according to claim 4,
wherein, when the time at which the storing of each program stream begins is instructed by the input device, a plurality of divided folders of the recording medium are designated, and, when the free capacity of the recording medium is small, each program file is transferred to the folders in a predetermined method.

20. The storing apparatus according to claim 19,
wherein, in the method of moving each program file to the folders when the free capacity of the recording medium is small, according to the number of times of recompression, each program file having a size of a predetermined magnification is outputted from the encoder.

21. The storing apparatus according to claim 19,
wherein, in the method of transferring each program file to the folders when the free capacity of the recording medium is small, the method of transferring each program file is determined through an interaction with a user of the storing apparatus.

22. The storing apparatus according to claim 1,
wherein each program stream is outputted to another storing apparatus according to claim 1, which is connected to the network, via the network.
